(19) United States
(12) Patent Application Publication
(10) Pub. No.: US 2002/0192099 A1
(43) Pub. Date: Dec. 19, 2002

(54) Tooth set for a hydraulic machine

(76) Inventors: Axel Patsch, Delmenhorst (DE); Tage Christiansen, Nordborg (DK); Hans Christian Petersen, Nordborg (DK); Jorgen Pedersen, Broager (DK)

Correspondence Address: Zarley Law Firm, Capital Square, 400 Locust Street Suite 200, Des Moines, IA, 50309-2350, US

(21) Appl. No.: 10/168,458

(22) PCT Filed: Dec. 20, 2000
(86) PCT No.: PCT/DK00/00718

(30) Foreign Application Priority Data
Dec. 23, 1999 (DE) 199 62 804.1

(51) Int. Cl. F01C 1/10; F03C 2/00; F04C 2/00; F03C 4/00; F04C 18/00

(52) U.S. Cl. 418/171

(57) ABSTRACT

The invention concerns a tooth set (1) for a hydraulic machine (2), particularly a hydraulic steering unit, with a toothed ring (3), a gear wheel (4) arranged inside the toothed ring (3), a first plate (7) on an axial front side of the gear wheel (4) and the toothed ring (3) and a second plate (5) on the other axial front side. A simplification of the production is endeavoured. For this purpose, the two plates (5, 7) and the parts between them, gear wheel (4) and toothed ring (3), can be handled as a self-retainingly assembled module (1).

The invention concerns a tooth set for a hydraulic machine, particularly a hydraulic steering unit, with a toothed ring, a gear wheel arranged inside the toothed ring, a first plate on an axial front side of the gear wheel and the toothed ring and a second plate on the other axial front side.

A tooth set of this kind is known from U.S. Pat. No. 3,289,602. Here, it serves as measuring motor, to make a first rotary slide of a steering device follow a second rotary slide, which is displaced by a steering handwheel.

Other examples of the use of such tooth sets are slowly operating hydraulic machines, that is, motors and pumps. For many decades, such tooth sets have proved their value in operation. However, the production of machines using this kind of tooth sets is relatively expensive. The tooth set is fixed on the machine by means of a number of bolts; the number of bolts usually corresponding exactly to the number of teeth of the toothed ring. Accordingly, the individual parts of the tooth set must either be assembled with the correct positioning and held against the machine for the insertion of the bolts, or the individual parts must be threaded onto the bolts and then screwed onto the machine as a package.

The invention is based on the task of simplifying the production.

With a tooth set as mentioned in the introduction, this task is solved in that the two plates and the parts between them, gear wheel and toothed ring, can be handled as a self-retainingly assembled module.

This simplifies the production drastically. The tooth set can also be assembled independently of the hydraulic machine, on which it will later be driven, for example in a production automat, which is exclusively adapted for the assembly of the tooth set. The module assembled this way can then be connected with the hydraulic machine as only component, this connection also being simplified, as the relatively large number of bolts required until now is no longer required. At the same time several problems are solved, which have occurred in connection of the fitting with bolts. Further, there is an additional advantage: The tooth sets can be tested already outside the hydraulic machine, that is, before being fitted on the hydraulic machine. It is also much easier, at a later time, to set the tooth set with regard to commutation on the hydraulic machine, as in fact only one part, namely the module, has to be handled, and not, as earlier, numerous parts, which were not assembled until fitted on the hydraulic machine by means of the bolts.

Preferably, the plates, the toothed ring and the gear wheel are arranged in a housing, having in the area of one plate a stop and in the area of the other plate a form-fitting or tensionally locked connection with the other plate. This simplifies the assembly of the module substantially. It is merely required to insert the individual parts in the housing one after the other, the movement opportunities of the parts exceeding a certain point being limited by the stop. The insertion of the other plate then practically finishes the build-up. Then, the second plate must be fixed in the housing. This fixing can, for example, be made by means of a frictional fitting, through which the plate is jammingly held in the housing. But, the housing can also be reshaped, for example in the area of the plate mentioned be at least partly bordered, to make the whole tooth set easy to handle. In this connection it must be noted that the connection between the individual parts of the tooth set does not have to be extremely stable. It must merely be sufficient to keep the individual parts of the tooth set together during handling. The forces through the hydraulic fluid, occurring during operation, can be seized by other measures and be led into the hydraulic machine.

In an alternative or additional embodiment it may be provided that the two plates and the toothed ring are connected with each other by gluing, welding or by means of catches. These connections are sufficient to make the tooth set module easy to handle. It is unimportant, whether they are able to resist the hydraulic forces, as the tooth set can be fixed on the hydraulic machine in such a way that the corresponding forces are under control.

Advantageously, a clamping ring is provided, which engages in a groove on the circumference of the tooth set and a corresponding groove on the machine. With this ring, the axial connection between the hydraulic machine and the tooth set can be managed. Depending on the embodiment of the ring, it must be damaged, when the tooth set has to be dismounted from the machine. However, it is also possible to use a ring, which can be opened like a band clamp.

In this connection, it is particularly preferred that in the mounted state the clamping ring is bent radially inwards. Thus, the clamping ring is pushed onto the connection spot of the tooth set and the machine in such a way that it covers both parts. Then, it can be bent into grooves made for this purpose, which is a relatively simple production process. Thus, the hydraulic forces during operation are reliably under control.

Preferably, the first plate is made as a distributor plate, which is penetrated by a supply channel arrangement, and the second plate is an end plate, which is supported in the housing. Thus, it is considered that due to the lack of bolts for the connection of the tooth set and the hydraulic machine there is a risk that the end plate lifts off from the toothed ring and the gear wheel, which could cause leakages. Therefore, the end plate can be supported in the housing, which gives the end plate an improved stability.

It is particularly preferred that on the side facing the housing, the end plate has an annular groove, which is connected with at least one tooth gap of the toothed ring via at least one first bore, and at least one second bore arranged in the area of the radial centre, a sealing ring being arranged between the annular groove and the second bore. This gives a hydraulic pressure balancing on both sides of the end plate. Through the bore the pressurised hydraulic fluid reaches both sides of the end plate, however only in an area radially outside the sealing ring. In this area, it is thus ensured that the end plate bears on gear wheel and toothed ring, so that here no large leakages can appear. In the radial centre, however, the pressure load caused by the hydraulic fluid disappears, so that the friction on the gear wheel remains small. Thus, a “softer” or somewhat less stable end plate can be used, which again gives advantages in connection with the production, particularly in the working of the end plate.

It is particularly preferred that the sealing ring surrounds a surface, which at least corresponds to the area, which is permanently covered by the gear wheel on one rotation of the gear wheel in the toothed ring. In this area, no pressure from the hydraulic fluid acts upon the inside of the end plate. Accordingly, it is not necessary to let a pressure occur on the outside of the end plate. In most cases, the area surrounded by the sealing ring will even be somewhat larger.

Preferably, the housing has a housing ring form-fittingly connected with a cover plate, which cooperates with the end plate. This simplifies the production of the housing. The connection of the cover plate and the housing ring can, for example, be effected in that the housing ring is bordered behind the cover plate.

Advantageously, the distributor plate has an adjustment arrangement, which enables an adjustment of the module in relation to the hydraulic machine, however permitting a displacement of module and machine by a small, predetermined angle. Thus, only little effort is required to ensure that the commutation is correct, when mounting the tooth set on the hydraulic machine. Thus, the tooth set has at least approximately the correct position on the hydraulic machine. The fact that also after mounting a small relative rotation between the tooth set and the machine can be effected, causes that the tooth set module can be even more accurately adjusted. Thus, the complete unit of tooth set module and machine gets even quieter, as pressure peaks, which usually cause noises, can be avoided or at least kept small.

Preferably, a sliding plate is arranged between at least one of the two plates on the one side and the toothed ring and the gear wheel on the other side, the sliding plate being made of a harder material than the corresponding plate. For example, the sliding plate can be made of reinforced steel or spring steel. Thus, it is avoided that the whole plate, which is covered by the sliding plate, must be made of a correspondingly hard material, for example a hardened steel. This enables an additional cost reduction.

Preferably, the toothed ring is built up of a plurality of segments, each segment forming a tooth. This gives several opportunities of building up the toothed ring, as the method of building up a closed unit from several modules no longer places so large requirements on the load capacity. The segments are relatively easy to produce, as they can be cut out from profiles, which are made in long lengths. Thus the adaptation of the tooth set to different supply volumes gets simpler. A substantial advantage involved in this is that the segments can be finished, for example hardened, before the mounting, which has not or only to a limited extent been possible with the traditional toothed rings. Also here the use of segments involves production technical savings. Additionally, the segments are an obvious choice, as they can simply be inserted in the housing without the use of bolts.

A particular advantage occurs in that each tooth is smoothed in the circumferential direction. Thus, the smoothing tracks are parallel to the movement, which the gear wheel will later perform in the toothed ring. This contributes to a reduction of the noise during operation, at least when compared with most of the presently known smoothing tracks, which are axis parallel and accordingly run traversely to the rotation direction of the gear wheel.

Preferably, each segment is hardened on the surface forming the tooth, and remaining parts of the segment are softer than the surface. Thus, the surface hardening is limited to the area, which is exposed to wear during operation. The remaining material of the teeth remains relatively soft, so that the teeth are more resilient. This also facilitates the production, as the fitting between gear wheel and toothed ring can be made with reduced accuracy. A so-called pair smoothing, which must be used today in connection with many tooth sets, can be avoided.

In a preferred embodiment, each segment is hollow. This makes the teeth even “softer”, so that they have an increased flexibility. Even though the deformations, which are enabled by this, are in the μm range, they are sufficient to permit working with a good inner sealing and relatively little wear.

Preferably, the profiles of the abutting joints of the segments are adapted to each other. This embodiment has several advantages. Firstly, the sealing radially outwards is somewhat improved in relation to an abutting joint extending in parallel to a radial beam. Secondly, the profiles also provide a certain frictional connection, so that the toothed ring as a whole becomes more stable.

Preferably, the segments are surrounded in the circumferential direction by a ring. The ring is then able to take up the forces appearing during operation, so that the requirements on the connections between the individual segments are smaller.

Preferably, the ring is a clamping band. Such a clamping band can, for example, be a steel band or a fibre-reinforced band. It can take up large forces without increasing the weight or the dimensions of the tooth set significantly.

In the following, the invention is described in detail on the basis of preferred embodiments in connection with the drawings, showing:

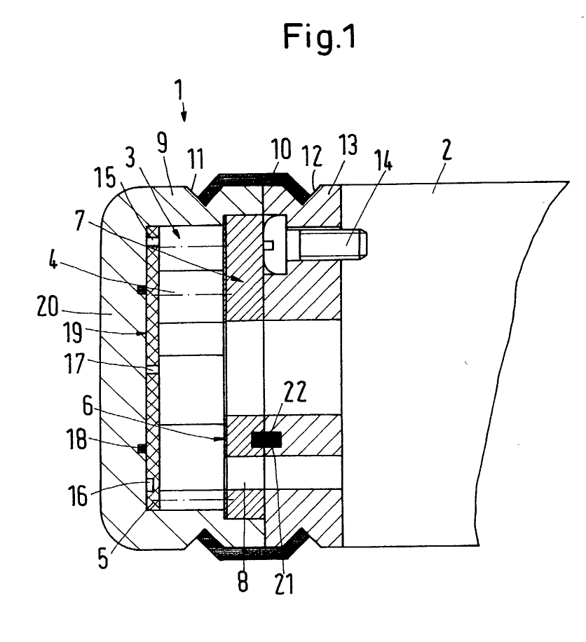

FIG. 1 a first embodiment of a tooth set

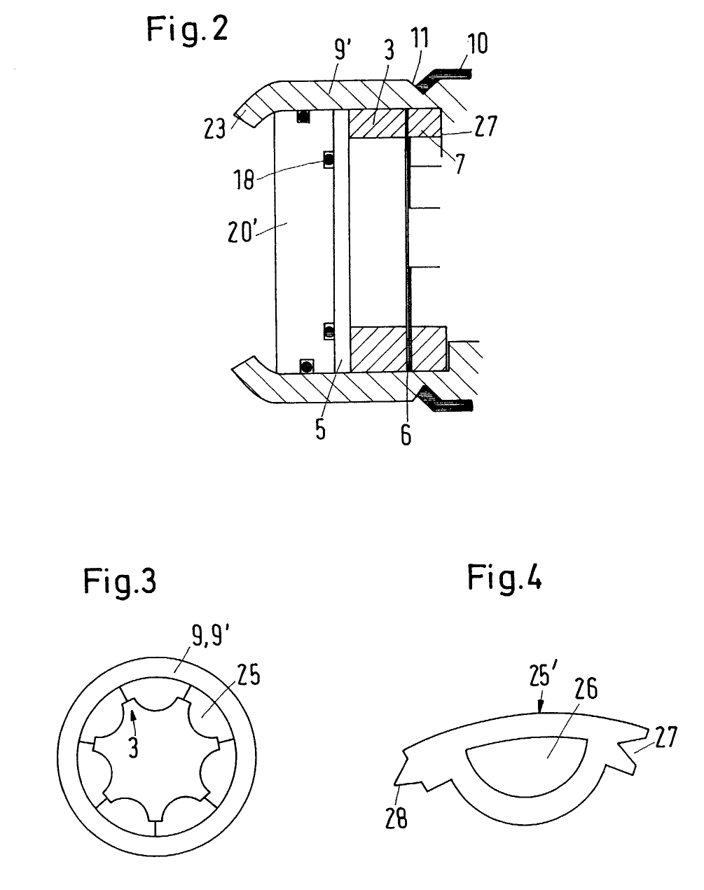

FIG. 2 a second embodiment of a tooth set

FIG. 3 a section through a toothed ring

FIG. 4 a tooth segment

A tooth set 1 for a hydraulic machine 2, here only shown schematically as a block, has a toothed ring 3, in which a gear wheel 4 is arranged. In the present embodiment, the toothed ring has one tooth more than the gear wheel 4. During operation the gear wheel rotates and orbits in the toothed ring. This creates pressure chambers with changing size between the gear wheel 4 and the toothed ring 3, which pressure chambers can be pressurised or released to cause a movement of the gear wheel 4 in the toothed ring 3, when the tooth set 1 works as a motor. In the reverse case, the tooth set 1 can also work as a pump.

On the left side (in FIG. 1) of the toothed ring 3 and the gear wheel 4 an end plate 5 is arranged, which is in the present case made of a relatively soft material, namely a plastic material. Also aluminium or other metals are possible. On the right front side of the toothed ring 3 and the gear wheel 4 a distributor plate 7 is arranged under insertion of a hard steel plate 6. In the distributor plate 7 openings 8 are provided, which serve the supply of the pressure chambers between the toothed ring 3 and the gear wheel 4.

This unit, comprising the two plates 5, 7, the toothed ring 3 and the gear wheel 4, is inserted in a barrel-shaped housing 9, whose bottom 10 forms a support for the end plate 5. Also the housing 9 can be made of, for example, aluminium. In the present case, the distributor plate 7 is held jammingly in the housing 9, so that an easy-to-handle module appears, which extends up to the right front side of the distributor plate 7. This module can be prefabricated and then fixed on the machine 2 in one piece.

For the fixing, a ring 10 is provided, which engages in a circumferential groove 11 on the housing 7 and a circumferential groove 12 on an intermediary plate 13, which is fixed on the machine 2 by means of screws 14. The intermediary plate 13 is only required, when the new tooth set 1 is to be fitted on an already existing machine 2. With adapted machines 2, the groove 12 may already be provided in the circumferential wall of the machine 2.

The ring 10 has an inner diameter, which corresponds to the outer diameter of the housing 9. When mounting, the ring 10 can thus be pushed onto the housing 9 and the intermediary plate 13 or the machine 2, respectively, in such a way that it overlaps the abutting joint. Then, the two axial ends of the ring 10 are bent or bordered into the grooves 11, 12. Instead of this, however, it is also possible to use a clamping ring in the manner of a pipe clamp. In the first case, the ring 10 must be damaged, when the tooth set 1 has to be dismounted from the machine 2. In the latter case, it is possible to open the ring.

As bolts for the fitting of tooth set 1 on machine 2 are no longer required, and thus are also not available for the support of the end plate 5, the pressure of the hydraulic fluid might cause the end plate 5 to be bent up into the tooth set 1, which might cause a leakage in the tooth set. To prevent this, a hydraulic balancing is provided. A bore 15 in the end plate 5, arranged in one, or if required, in each of the tooth gaps in the toothed ring 3, is connected with an annular groove 16, arranged on the side facing the bottom 20 of the housing, which groove is, if required, interrupted for each tooth of the toothed ring 3. In the radial centre of the end plate 5 a second bore 17 is provided. Between the annular groove 16 and the bore 17 is arranged a sealing ring 18, surrounding an area 19, which is at least the same size as an area on the other side of the end plate 5, which is covered by the gear wheel 4, independently of the position of the gear wheel 4. Thus, hydraulic fluid under pressure can penetrate to the area, which lies outside the sealing ring 18, and press the end plate 5 with the required force against the front side of the gear wheel 4 and the toothed ring 3. In the middle of the gear wheel, however, this pressure is not available or at least is small enough to prevent an excessive friction from occurring. In many cases, the bore 15 and the annular groove 16 are not required, when, due to leakages, the same pressure exists on both sides of the end plate 5.

A guiding pin 21 is inserted in the distributor plate 7, so that, when the tooth set 1 is fixed on the machine 2, it projects into a corresponding bore 22 on the intermediary plate 13 or the machine 2. In the circumferential direction, the bore 22 is slightly larger than the guiding pin 21 so that in a small area the tooth set 1 can be turned in relation to the machine 2. Thus, the commutation of the tooth set 1 in relation to the machine can be set so that the tooth set 1 can work with even less noise. The turning will namely result in an elimination of pressure peaks, which would otherwise give rise to noise. To put it simple, the setting can be made “by ear”.

Additionally, it may be provided that the individual parts 5, 3, 6, 7 are connected with each other before mounting, for example by gluing, welding or by means of catches or another way of fixing. Also this connection only has to be so stable that it enables the handling of the connected parts as one unit. The forces occurring during operation will be absorbed by the housing 9, 20.

FIG. 2 shows a slightly modified embodiment, in which parts being the same as those in FIG. 1 have the same reference numbers. The difference lies in that in this embodiment the housing consists of a housing ring 9′ and a bottom plate 20′ connected with the housing ring, the bottom plate 20′ being held in the housing ring 9′ by the housing ring 9′ being bordered on the outside of the bottom plate 20′ thus forming holding fingers 23. For this purpose the housing ring 9′ has on its other side a step 27, which holds the distributor plate 7.

The fact that now an assembled module is available, which forms a closed unit, which is kept together in the housing 9, 20 or 9′, 20′, respectively, gives several opportunities of designing the toothed ring 3, as the demands on strength are no longer as heavy as before. Thus, FIG. 3 shows an example of a toothed ring 3, which has several segments 25 in the housing 9, 9′, each segment being a tooth. This permits a substantial simplification of the production of the toothed ring 3, as the individual segments 25 can be cut off from a profile, which can be produced cheaply in long lengths. This also simplifies the adaptation to different supply volumes, as the length of the segments can simply be changed.

A large advantage is also that the segments 25 can be finished from the outside, for example, hardened. Traditional toothed rings could only be finished from the inside. Also this enables savings in connection with the production.

Additionally, the individual segments can be smoothed so that the smoothing tracks in the toothed ring run in the circumferential direction, that is, parallel to the direction in which the gear wheel 4 passes the individual teeth of the toothed ring 3. Compared with smoothing tracks running perpendicularly to this direction, this permits a very heavy noise reduction.

The hardening of the surface can be made exactly where the gear wheel moves across the toothed ring. However, the surface hardening can also be limited to this area, so that the remaining material of the segments remains relatively soft, meaning that the teeth will be resilient. A toothed ring 3 of this kind can then be surrounded by a ring, or a steel band could be wound around the segments 25 to keep them together. Finally, also glass or carbon fibre reinforced bands could be used, which, with a small radial extension, cause a high mechanical stability.

FIG. 4 shows a modified segment 25′, which firstly has a hollow chamber 26, which means that the tooth arranged on the segment 25′ gets even softer. Secondly, on the two ends in the circumferential direction, the segment 25′ has profilings 27, 28 adapted to each other. When now the individual segments 25′ are assembled in the circumferential direction, one profile 28 will always engage with the profile 27 of the next segment 25′, which increases the stability.

1. Tooth set for a hydraulic machine, particularly a hydraulic steering unit, with a toothed ring, a gear wheel arranged inside the toothed ring, a first plate on an axial front side of the gear wheel and the toothed ring and a second plate on the other axial front side, characterised in that the two plates (5; 6, 7) and the parts between them, gear wheel (4) and toothed ring (3), can be handled as a self-retainingly assembled module.

2. Tooth set according to claim 1, characterised in that the plates (5; 6, 7), the toothed ring (3) and the gear wheel (4) are arranged in a housing (9, 20; 9′, 20′), having in the area of one plate (5) a stop and in the area of the other plate (7) a form-fitting or tensionally locked connection with the other plate (7).

3. Tooth set according to claim 1 or 2, characterised in that the two plates (5; 6, 7) and the toothed ring (3) are connected with each other by-gluing, welding or by means of catches.

4. Tooth set according to one of the claims 1 to 3, characterised in that a clamping ring (10) is provided, which engages in a groove (11) on the circumference of the tooth set (1) and a corresponding groove (12) on the machine (2, 13).

5. Tooth set according to claim 4, characterised in that in the mounted state the clamping ring (10) is bent radially inwards.

6. Tooth set according to one of the claims 1 to 5, characterised in that the first plate (7) is made as a distributor plate, which is penetrated by a supply channel arrangement (8), and the second plate (5) is an end plate, which is supported in the housing (9).

7. Tooth set according to claim 6, characterised in that on the side facing the housing (9), the end plate (5) has an annular groove (16), which is connected with at least one tooth gap of the toothed ring (3) via at least one first bore (15), and at least one second bore (17) arranged in the area of the radial centre, a sealing ring (18) being arranged between the annular groove (16) and the second bore (18).

8. Tooth set according to claim 7, characterised in that the sealing ring (18) surrounds a surface (19), which at least corresponds to the area, which is permanently covered by the gear wheel (4) on one rotation of the gear wheel (4) in the toothed ring (3).

9. Tooth set according to one of the claims 6 to 8, characterised in that the housing (9′, 20′) has a housing ring (9′) form-fittingly connected with a cover plate (20′), which cooperates with the end plate (5).

10. Tooth set according to one of the claims 6 to 9, characterised in that the distributor plate (7) has an adjustment arrangement (21), which enables an adjustment of the module in relation to the hydraulic machine (2), however permitting a displacement of module and machine (2) by a small, predetermined angle.

11. Tooth set according to one of the claims 6 to 9, characterised in that a sliding plate (6) is arranged between at least one of the two plates (5, 7) on the one side and the toothed ring (3) and the gear wheel (4) on the other side, the sliding plate (6) being made of a harder material than the corresponding plate (5, 7).

12. Tooth set according to one of the claims 1 to 11, characterised in that the toothed ring (3) is built up of a plurality of segments (25, 25′), each segment forming a tooth.

13. Tooth set according to claim 12, characterised in that each tooth is smoothed in the circumferential direction.

14. Tooth set according to claim 12 or 13, characterised in that each segment (25, 25′) is hardened on the surface forming the tooth, and remaining parts of the segment (25, 25′) are softer than the surface.

15. Tooth set according to claim 14, characterised in that each segment (25′) is hollow.

16. Tooth set according to one of the claims 12 to 15, characterised in that the profiles (27, 28) of the abutting joints of the segments (25) are adapted to each other.

17. Tooth set according to one of the claims 12 to 16, characterised in that in the circumferential direction the segments (25, 25′) are covered by a ring (9, 9′).

18. Tooth set according to claim 17, characterised in that the ring (9, 9′) is a clamping band.
